(19) United States
(12) Patent Application Publication
(10) Pub. No.: US 2018/0286324 A1
(43) Pub. Date: Oct. 4, 2018

(54) LIQUID CRYSTAL DISPLAY APPARATUS

(71) Applicants: HKC Corporation Limited, Shenzhen City, Guangdong (CN); Chongqing HKC Optoelectronics Technology Co., Ltd., Chongqing (CN)

(72) Inventor: Yu-Jen CHEN, Chongqing (CN)

(21) Appl. No.: 15/561,709

(22) PCT Filed: Aug. 16, 2017
(86) PCT No.: PCT/CN2017/097607

§ 371 Date: Sep. 26, 2017

(30) Foreign Application Priority Data
Mar. 30, 2017 (CN) 201710203353.5

(51) Int. Cl. G09G 3/36; G02F 1/1347; G02F 1/137; G02F 1/13; G02F 1/133

(52) U.S. Cl. CPC G09G 3/36; G02F 1/13476; G02F 2001/13756; G02F 1/1323; G02F 1/13306; G02F 1/137

(57) ABSTRACT

This application provides a liquid crystal display apparatus, including: a backlight module, a liquid crystal display panel disposed on the backlight module, where the liquid crystal display panel includes a plurality of image pixels arranged in arrays; a liquid crystal dimming panel disposed on the liquid crystal display panel, where the liquid crystal dimming panel has a transparent state and a scattering state, the liquid crystal dimming panel in the transparent state allows an image including the image pixels to be directly viewed from a front face, and the liquid crystal dimming panel in the scattering state allows light emitted from the image pixels to be refracted and adjusted.

### BACKGROUND

### Technical Field

This application relates to the technical field of liquid crystal imaging devices, and in particular, to a liquid crystal display apparatus and a method for reducing a color difference at a viewing angle thereof.

### Related Art

At present, large-sized liquid crystal display panels are usually manufactured by using a negative vertical alignment (VA) liquid crystal technology or an in-plane switching (IPS) liquid crystal technology. Compared with the IPS liquid crystal technology, the VA liquid crystal technology features high production efficiency and low manufacturing costs, but has more obvious disadvantages in optical properties. However, in commercial applications, a large-sized liquid crystal panel particularly requires a large viewing angle for presentation. A liquid crystal display panel using the VA liquid crystal technology has a problem of a color difference at a viewing angle, and consequently cannot meet a market requirement.

Generally, in the VA liquid crystal technology, subpixels in an image pixel group are further divided into primary pixels and secondary pixels, and different drive voltages are applied to the primary pixels and the secondary pixels in space, so as to avoid the color difference at the viewing angle. However, in such pixel design, metal wiring or a thin film transistor (TFT) component usually needs to be further designed to drive the secondary pixels, causing the loss of a transparent opening area. Consequently, not only the penetration rate of a liquid crystal display panel is affected, but also the manufacturing costs of a backlight module are increased.

### SUMMARY

An objective of this application is to provide a liquid crystal display apparatus and a method for reducing a color difference at a viewing angle thereof, so as to resolve a technical problem of a color difference at a viewing angle of a liquid crystal display apparatus using a VA liquid crystal technology in the related art.

To achieve to foregoing objective, this application provides a liquid crystal display apparatus, comprising:

a backlight module;

a liquid crystal display panel, disposed on the backlight module, where the liquid crystal display panel comprises a plurality of image pixels arranged in arrays; and

a liquid crystal dimming panel, disposed on the liquid crystal display panel, where the liquid crystal dimming panel has a transparent state and a scattering state, the liquid crystal dimming panel in the transparent state allows an image represented by the image pixels to be directly viewed from a front face, and the liquid crystal dimming panel in the scattering state allows light emitted from the image pixels to be refracted and adjusted, where

light emitted from the backlight module is directed to the image pixels on the liquid crystal display panel, and an angular deviation between the light emitted from the backlight module and the image pixels is equal to or less than 10 degrees; and

the liquid crystal dimming panel has at least two pairs of dimming areas, and the at least two pairs of dimming areas are located in pairs at two sides of the liquid crystal display panel and used for adjusting the light emitted from the image pixels.

This application further provides a liquid crystal display apparatus, comprising: a backlight module; a liquid crystal display panel, where the liquid crystal display panel is overlaid with the backlight module, a plurality of image pixel groups arranged in arrays are disposed on the liquid crystal display panel, and each image pixel group comprises a plurality of image pixels; a liquid crystal dimming panel, where the liquid crystal dimming panel is overlaid with the liquid crystal display panel, and the liquid crystal display panel is located between the backlight module and the liquid crystal dimming panel. Drive voltages in locations on the liquid crystal dimming panel relative to the different image pixel groups are controlled, so as to control photon energy adjustment, at a viewing angle, between liquid crystal molecules in the liquid crystal dimming panel.

Further, a plurality of dimming pixels are disposed on the liquid crystal dimming panel, and the drive voltage is a drive voltage of each dimming pixel on the liquid crystal dimming panel.

Further, the dimming pixels are disposed in a one-to-one correspondence with the image pixel groups on the liquid crystal display panel.

Further, the dimming pixels are disposed in a one-to-one correspondence with the image pixels in the image pixel groups.

Further, two opposite surfaces of the liquid crystal dimming panel both comprise a transparent conductive film, and the drive voltages in the locations on the liquid crystal dimming panel relative to the different image pixel groups are controlled by means of wiring on the transparent conductive film, so as to control the photon energy adjustment, at the viewing angle, between the liquid crystal molecules in the liquid crystal dimming panel.

Further, the backlight module provides backlight for the liquid crystal display panel, and the backlight is collimated light illuminating the liquid crystal display panel.

Further, the backlight module comprises one or more light emitting points.

Further, a spotlight component is disposed at the light emitting point.

Further, the liquid crystal display apparatus further comprises a signal modem configured to modulate or demodulate a picture signal received by the liquid crystal display apparatus and a controller electrically connected to the signal modem, and the controller controls, according to the signal modulated or demodulated by the signal modem, a drive voltage of the image pixel on the liquid crystal display panel and the drive voltage of the dimming pixel on the liquid crystal dimming panel.

Further, the liquid crystal display apparatus further comprises an eye tracking apparatus electrically connected to the controller and configured to track and determine a location of the eyes of a viewer relative to the liquid crystal display apparatus.

Further, the eye tracking apparatus is a charge coupled device (CCD) positioning apparatus.

The liquid crystal display apparatus provided in this application comprises the liquid crystal display panel, the liquid crystal dimming panel, and the backlight module. The backlight module is configured to illuminate the liquid crystal display panel, to enable the liquid crystal display panel to display an image. Because the liquid crystal dimming panel is disposed on the liquid crystal display panel, the drive voltages in the locations on the liquid crystal dimming panel relative to the different image pixel groups are controlled, to change an arrangement state of the liquid crystal molecules in the liquid crystal dimming panel, so that the photon energy adjustment at the viewing angle is performed between the liquid crystal molecules in the liquid crystal dimming panel, thereby achieving the effect of color uniformity at the full viewing angle, and further reducing a color difference at a viewing angle of a liquid crystal display apparatus using a VA liquid crystal technology.

Another technical solution of this application is a method for reducing a color difference at a viewing angle of a liquid crystal display apparatus, comprising the following steps:

providing a backlight module, a liquid crystal display panel, and a liquid crystal dimming panel;

performing backlight illumination on image pixel groups on the liquid crystal display panel by using the backlight module; and

disposing the liquid crystal dimming panel on the liquid crystal display panel, and controlling drive voltages in locations on the liquid crystal dimming panel relative to the different image pixel groups, to control photon energy adjustment, at a viewing angle, between liquid crystal molecules in the liquid crystal dimming panel.

In the method for reducing a color difference at a viewing angle of a liquid crystal display apparatus provided in this application, because the liquid crystal dimming panel is disposed on the liquid crystal display panel, the drive voltages in the locations on the liquid crystal dimming panel relative to the different image pixel groups are controlled, to change an arrangement state of the liquid crystal molecules in the liquid crystal dimming panel, so that the photon energy adjustment at the viewing angle is performed between the liquid crystal molecules in the liquid crystal dimming panel, thereby achieving the effect of color uniformity at the full viewing angle, and further reducing a color difference at a viewing angle of a liquid crystal display apparatus using a VA liquid crystal technology

### BRIEF DESCRIPTION OF THE DRAWINGS

FIG. 1 is a first schematic exploded structural view of a liquid crystal display apparatus according to an embodiment of this application;

FIG. 2 is a second schematic exploded structural view of a liquid crystal display apparatus according to an embodiment of this application;

FIG. 3 is a third schematic exploded structural view of a liquid crystal display apparatus according to an embodiment of this application;

FIG. 4 is a schematic diagram of a turned-on state of a power switch on a liquid crystal dimming panel of a liquid crystal display apparatus according to an embodiment of this application;

FIG. 5 is a schematic diagram of a turned-off state of a power switch on a liquid crystal dimming panel of a liquid crystal display apparatus according to an embodiment of this application; and

FIG. 6 is a schematic diagram of a liquid crystal display apparatus according to an embodiment of this application.

### DETAILED DESCRIPTION

The following describes embodiments of this application in detail. Examples of the embodiments are shown in the accompanying drawings, and same or similar reference numbers in the accompanying drawings indicate same or similar components or components having a same or similar function. The embodiments described below with reference to the accompanying drawings are exemplary and are intended to explain this application, and cannot be understood as a limitation to this application.

In descriptions of this application, it should be understood that directions or location relationships indicated by terms such as “length”, “width”, “on”, “below”, “front”, “back”, “left”, “right”, “vertical”, “horizontal”, “top”, “bottom”, “in”, and “out” are directions or location relationships shown based on the accompanying drawings, are merely intended to describe this application and simplify the descriptions rather than indicate or imply that a specified apparatus or component needs to be in a particular position or manufactured and operated in a particular position, and therefore cannot be understood as a limitation to this application.

In addition, terms “first” and “second” are merely intended to describe objectives, and cannot be understood as indicating or implying relative importance or implicitly indicating a quantity of specified technical features. In view of this, features defined by “first” or “second” may explicitly or implicitly include one or more features. In the descriptions of this application, “a plurality of” means two or more, unless otherwise definitely and specifically limited.

In this application, unless otherwise definitely specified and limited, terms such as “install”, “joint”, “connect”, and “fix” should be generally understood as, for example, being fixedly connected, detachably connected, or integrated; mechanically connected or electrically connected; directly connected or indirectly connected by using an intermediate medium; or internal communication between two components or an interaction relationship between two components. A person of ordinary skill in the art may understand specific meanings of the terms in this application according to specific conditions.

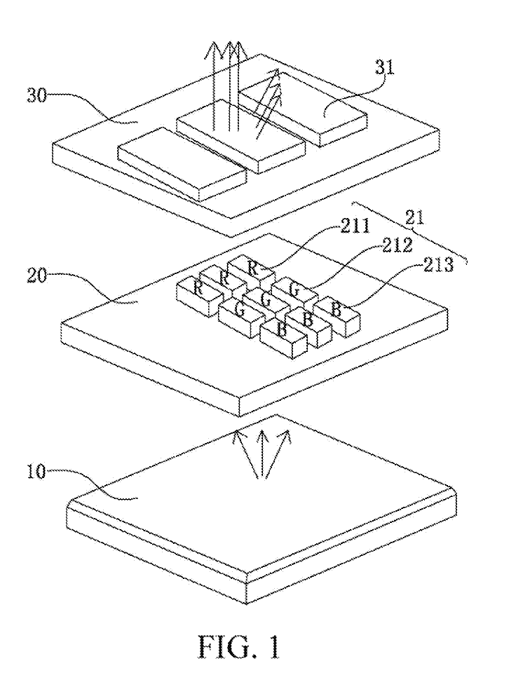

As shown in FIG. 1 to FIG. 3, a liquid crystal display apparatus provided in an embodiment of this application includes: a backlight module 10, a liquid crystal display panel 20, where the liquid crystal display panel 20 being overlaid with the backlight module 10, a plurality of image pixel groups 21 arranged in arrays are disposed on the liquid crystal display panel 20, and each image pixel group 21 includes a plurality of image pixels; and a liquid crystal dimming panel 30, where the liquid crystal dimming panel 30 is overlaid with the liquid crystal display panel 20, and the liquid crystal display panel 20 is located between the backlight module 10 and the liquid crystal dimming panel 30. Drive voltages in locations on the liquid crystal dimming panel 30 relative to the different image pixel groups 21 are controlled, so as to control photon energy adjustment, at a viewing angle, between liquid crystal molecules in the liquid crystal dimming panel 30.

In this embodiment, the liquid crystal display panel 20 may be a VA type liquid crystal display panel 20, a twisted nematic (TN) type liquid crystal display panel 20, an optically compensated birefringence (OCB) type liquid crystal display panel 20, a curved display panel, or a COA type liquid crystal display panel, or may be a VA type liquid crystal display panel 20 having no compensation film polarizer, a TN type liquid crystal display panel 20 having no compensation film polarizer, or an OCB type liquid crystal display panel 20 having no compensation film polarizer. During actual application, one of them may be selected as the liquid crystal display panel 20 of the liquid crystal display apparatus. Certainly, in another embodiment of this application, a liquid crystal panel of another type may be selected as the liquid crystal display panel 20 of the liquid crystal display apparatus. This is not uniquely limited herein.

As shown in FIG. 1 to FIG. 3, in this embodiment, the a plurality of image pixel groups 21 arranged in arrays on the liquid crystal display panel 20 may be an RGB (Red, Green, and Blue) image pixel group 21, a WRGB (White, Red, Green, and Blue) image pixel group 21, or an RGBY (Red, Green, Blue, and Yellow) image pixel group 21. Certainly, the image pixel group 21 may also be a combination of image pixels of other colors. This is not limited herein. The RGB image pixel group 21 includes a red image pixel 211, a green image pixel 212, and a blue image pixel 213. Similarly, the WRGB image pixel group 21 includes a white image pixel, a red image pixel 211, a green image pixel 212, and a blue image pixel 213. The RGBY image pixel group 21 includes a red image pixel 211, a green image pixel 212, a blue image pixel 213, and a yellow image pixel.

In addition, in this embodiment, a liquid crystal filling process for the liquid crystal display panel 20 is the same as a that in the related art.

During use, the backlight module 10 is configured to provide backlight illuminating the liquid crystal display panel 20. Drive voltages in locations of the different image pixel groups 21 on the liquid crystal display panel 20 are controlled, to change an arrangement state of liquid crystal molecules in the liquid crystal display panel 20, thereby implementing imaging using the liquid crystal display panel 20. In this embodiment, because the liquid crystal dimming panel 30 is overlaid with the liquid crystal display panel 20, the drive voltages in the locations on the liquid crystal dimming panel 30 relative to different image pixel groups 21 can be controlled, to change an arrangement state of the liquid crystal molecules in the liquid crystal dimming panel 30, so that the photon energy adjustment at the viewing angle is performed between the liquid crystal molecules in the liquid crystal dimming panel 30, thereby achieving the effect of color uniformity at the full viewing angle, resolving a problem of a color difference at a viewing angle of a liquid crystal display apparatus using a VA liquid crystal technology, and meeting a market requirement.

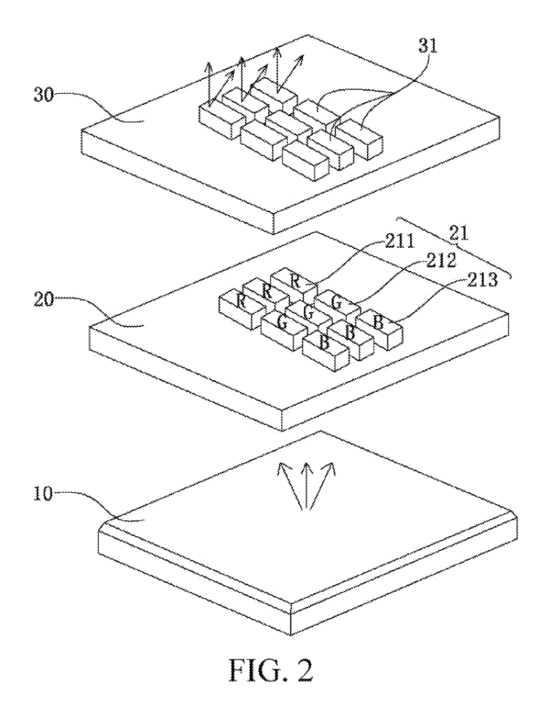

As shown in FIG. 1 and FIG. 2, further, a plurality of dimming pixels 31 are disposed on the liquid crystal dimming panel 30, and the drive voltage is a drive voltage of each dimming pixel 31 on the liquid crystal dimming panel 30. Each dimming pixel 31 on the liquid crystal dimming panel 30 can be separately driven, and the drive voltage of each dimming pixel 31 is controlled, so that an image displayed on the liquid crystal display apparatus can be precisely adjusted according to different viewing angle ranges, thereby achieving the effect of color uniformity at the full viewing angle, and improving the user experience.

In this embodiment, the liquid crystal dimming panel 30 is a polymer dispersed liquid crystal (PDLC) array liquid crystal panel. PDLC is obtained by mixing liquid crystals (LC) and prepolymer Kuer UV65 glue, performing a polymerization reaction under a particular condition to form micron-sized liquid crystal microdroplets 352 uniformly dispersed in a network of a high-molecular polymer 351, and then obtaining a material having an electronic-optical response characteristic by means of dielectric anisotropy of liquid crystal molecules. The PDLC mainly works between a scattering state and a transparent state and has a particular grayscale.

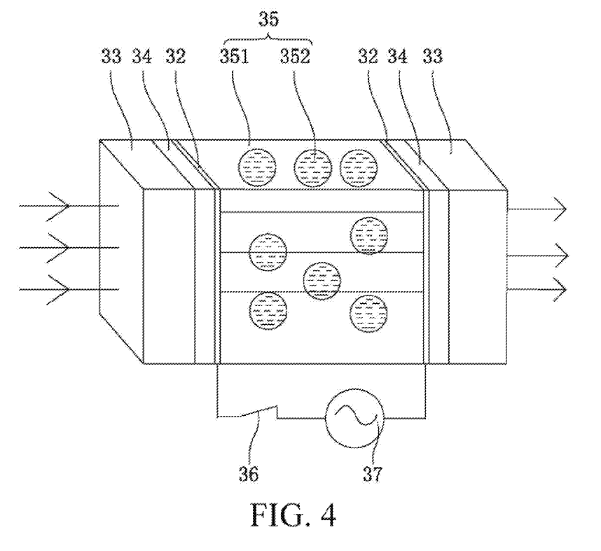

As shown in FIG. 4, when a switch 36 of a power supply 37 on the PDLC array liquid crystal panel is turned on, optical axes of the liquid crystal microdroplets 352 located in the PDLC array liquid crystal panel are arranged perpendicular to a surface of a transparent conductive thin film and are consistent with an electric field in direction. In this case, an extraordinary light refractive index of the liquid crystal microdroplets 352 is basically matched with an refractive index of the polymer 351, and there is no obvious gap between the liquid crystal microdroplets 352 and the polymer 351. A polymer dispersed liquid crystal layer 35 is a basically uniform medium. Incident light reaches the polymer dispersed liquid crystal layer 35 after passing through a glass board 33, an interlayer 34, and a transparent conductive film 32, and then exits through a transparent conductive film 32, a transparent conductive film 32, and a glass board 33 on the opposite side. The incident light is not scattered in the polymer dispersed liquid crystal layer 35, and emergent light exits perpendicular to the glass board 33. Therefore, the polymer dispersed liquid crystal layer 35 is in a transparent state. In this way, a viewer can view a colorful picture from a front face of the liquid crystal display apparatus.

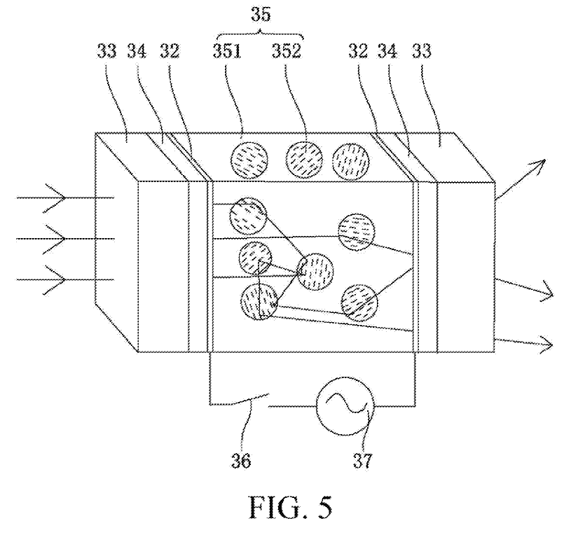

As shown in FIG. 5, when the switch 36 of the power supply 37 on the PDLC array liquid crystal panel is turned off or the drive voltages on the PDLC array liquid crystal panel are controlled to change, the optical axes of the liquid crystal microdroplets 352 located in the PDLC array liquid crystal panel are randomly orientated and in a disorder state. In this case, an effective refractive index of the liquid crystal microdroplets 352 is not matched with the refractive index of the polymer 351, a regular electric field cannot be formed in the polymer dispersed liquid crystal layer 35. Incident light is strongly scattered. The incident light is reflected and refracted in a plurality of directions in the polymer dispersed liquid crystal layer 35 for propagation after passing through the glass board 33, the interlayer 34, and the transparent conductive film 32, and then irregularly emits from a plurality of directions by passing through the transparent conductive film 32, an interlayer 34, and the glass board 33 on the opposite side. Therefore, the polymer dispersed liquid crystal layer 35 is in a non-transparent state or a semi-transparent state. In this case, photon energy adjustment at a viewing angle of the liquid crystal display panel 20 can be performed according to a different location of the viewer, so that energy at a front viewing angle of the liquid crystal display panel 20 is allocated toward a large viewing angle, thereby ensuring that a picture color and picture quality presented to the viewer in the location is the same as those viewed at the front viewing angle.

As shown in FIG. 1, further, the dimming pixels 31 are disposed in a one-to-one correspondence with the image pixel groups 21 on the liquid crystal display panel 20. Such design can effectively reduce the resolution of the liquid crystal dimming panel 30, reduce a quantity of drive lines and a quantity of drive components on the liquid crystal dimming panel 30, and increase the light transmittance of the liquid crystal dimming panel 30. Certainly, each dimming pixel 31 may be disposed corresponding to a plurality of neighboring image pixel groups 21 on the liquid crystal display panel 20. It should be further noted that such pixel design is applicable to a case in which the area of a local region of the dimming pixel 31 is sufficiently large and human eyes cannot recognize the color non-uniformity between different local regions.

As shown in FIG. 2, further, the dimming pixels 31 are disposed in a one-to-one correspondence with the image pixels in the image pixel groups 21. In this case, the dimming pixels 31 on the liquid crystal dimming panel 30 disposed in a one-to-one correspondence with the image pixels on the liquid crystal display panel 20 can be separately controlled and driven, so as to properly compensate for color presentation in the locations of different color blocks on the liquid crystal display panel 20. The locations of the different color blocks on the liquid crystal display panel 20 may also have a function of particularly enhancing local hue presentation, so as to stress presentation of a highly saturated hue.

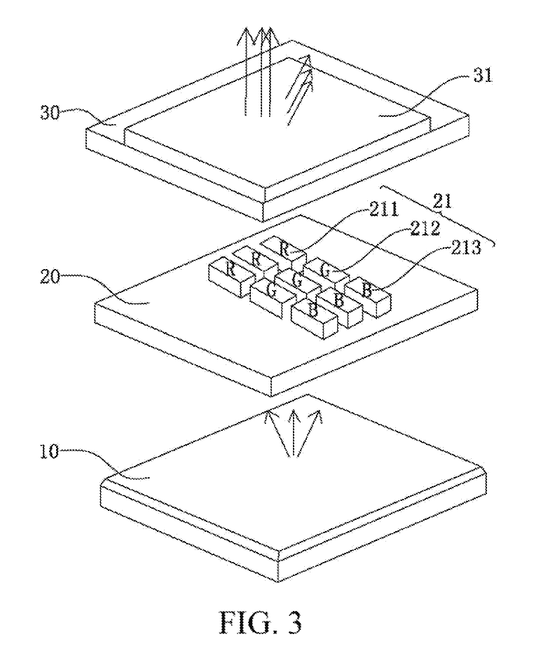

As shown in FIG. 3, further, two opposite surfaces of the liquid crystal dimming panel 30 both include a transparent conductive film 32, and the drive voltages in the locations on the liquid crystal dimming panel 30 relative to the different image pixel groups 21 are controlled by means of wiring on the transparent conductive film 32, so as to control the photon energy adjustment, at the viewing angle, between the liquid crystal molecules in the liquid crystal dimming panel 30. The transparent conductive film 32 may be a metal transparent conductive film 32 made of Ag, Pt, Cu, Rh, or the like, or may be a transparent conductive thin film made from oxide of In, Sn, Zn, or Cd or multi-component complex oxide thereof. Preferably, the transparent conductive thin film is an indium tin oxide (ITO) transparent conductive thin film, and the ITO transparent conductive thin film has desirable light transmittance and electrical conductivity.

As shown in FIG. 1 to FIG. 3, further, the backlight module 10 provides the backlight for the liquid crystal display panel 20, and the backlight is collimated light illuminating the liquid crystal display panel 20. Preferably, in this embodiment, a ⅓-luminance viewing angle of the liquid crystal display apparatus is less than 10°. For example, the ⅓-luminance viewing angle of the liquid crystal display apparatus may be 2°, 4°, 6°, or 8°. In such design, light emitted from the backlight module 10 can still maintain forward photon energy after passing through the liquid crystal display panel 20. Therefore, photon energy can be effectively and properly allocated, thereby saving energy and electricity. The ⅓-luminance viewing angle is a horizontal or vertical viewing angle when luminance at the screen center is decreased to ⅓ of maximum luminance.

In this embodiment, the backlight module 10 may include one or more light emitting points. Preferably, when the backlight module 10 includes a plurality of light emitting points, the plurality of light emitting points are disposed in a one-to-one correspondence with the image pixels on the liquid crystal display panel 20, so that collimated light emitted from each light emitting point of the backlight module 10 can intensively illuminate the corresponding image pixel on the liquid crystal display panel 20, and light that exits the liquid crystal display panel 20 can maintain forward photon energy, thereby improving the optical efficiency, and effectively using the photon energy.

Specifically, the light emitting point of the backlight module 10 may be a lamp, a light emitting diode, a cold-cathode fluorescent tube, a hot-cathode fluorescent tube, an electroluminescent sheet, an organic electroluminescent sheet, a flat fluorescent lamp, or the like. Certainly, a light emitting source of another type may be selected as the light emitting point of the backlight module 10 in another embodiment of this application. This is not uniquely limited herein. In addition, in this embodiment, a corresponding spotlight component may be further disposed at each light emitting point of the backlight module 10. The spotlight component may be a spotlight lens, an optical film used for spotlighting, or the like. In such case, the light emitting point of the backlight module 10 may be selected as a normal light emitting source of scattered light, and scattered light emitted from the light emitting source forms collimated light after being converged by the spotlight component, and then illuminates the liquid crystal display panel 20.

Further, the liquid crystal display apparatus further includes a signal modem (not shown) configured to modulate or demodulate a picture signal received by the liquid crystal display apparatus and a controller (not shown) electrically connected to the signal modem. The controller controls, according to the signal modulated or demodulated by the signal modem, a drive voltage of the image pixel on the liquid crystal display panel 20 and the drive voltage of the dimming pixel 31 on the liquid crystal dimming panel 30. After the liquid crystal display apparatus receives the picture signal, the signal modem modulates or demodulates the picture signal, and then the modulated or demodulated signal is transmitted back to the controller. The controller controls an image of the liquid crystal display panel 20 according to the signal, and also controls the liquid crystal dimming panel 30 to adjust picture colors viewed in different viewing angle ranges. Therefore, the problem of a color difference at a viewing angle of the liquid crystal display apparatus is resolved, and the viewer can obtain, from different viewing angles, a picture effect the same as a picture effect at a front viewing angle.

Further, the liquid crystal display apparatus further includes an eye tracking apparatus (not shown) electrically connected to the controller and configured to track and determine a location of the eyes of the viewer relative to the liquid crystal display apparatus. When the location of the viewer relative to the liquid crystal display apparatus changes, the eye tracking apparatus can instantly capture a movement behavior of the viewer and detects new location information of the viewer relative to the liquid crystal display apparatus. Then, the eye tracking apparatus further transmits, to the controller, the detected new location information of the viewer relative to the liquid crystal display apparatus. The controller controls the drive voltage of the liquid crystal dimming panel 30 according to the location information, and adjusts a ratio of liquid crystal scattering to light transmission of the polymer 351 in the liquid crystal dimming panel 30 in a timely manner. Different photon energy compensation amounts are provided for different viewing angles, to improve the quality of a picture displayed after the location of the viewer changes, so that there is no color difference from any viewing angles.

Further, the eye tracking apparatus is a CCD positioning apparatus. A CCD is also referred to as an image controller or a CCD image sensor. The CCD positioning apparatus features high resolution, high sensitivity, a wide dynamic range, low image distortion, a large photosensitive area, and the like. Certainly, according to an actual case and requirement, in another embodiment of this application, the eye tracking apparatus may be any other device capable of implementing a tracking and positioning function. This is not uniquely limited herein.

An embodiment of this application further provides a method for reducing a color difference at a viewing angle of a liquid crystal display apparatus, including the following steps:

providing a backlight module 10, a liquid crystal display panel 20, and a liquid crystal dimming panel 30;
performing backlight illumination on image pixel groups 21 on the liquid crystal display panel 20 by using the backlight module 10; and
disposing the liquid crystal dimming panel 30 on the liquid crystal display panel 20, and controlling drive voltages in locations on the liquid crystal dimming panel 30 relative to the different image pixel groups 21, to control photon energy adjustment, at a viewing angle, between liquid crystal molecules in the liquid crystal dimming panel 30.

In the method for reducing a color difference at a viewing angle of a liquid crystal display apparatus provided in this embodiment of this application, because the liquid crystal dimming panel 30 is overlaid with the liquid crystal display panel 20, the drive voltages in the locations on the liquid crystal dimming panel 30 relative to the different image pixel groups 21 are controlled, to change an arrangement state of the liquid crystal molecules in the liquid crystal dimming panel 30, so that the photon energy adjustment at the viewing angle is performed between the liquid crystal molecules in the liquid crystal dimming panel 30, thereby achieving the effect of color uniformity at the full viewing angle, resolving a problem of a color difference at a viewing angle of a liquid crystal display apparatus using a VA liquid crystal technology, and meeting a market requirement.

It should be further noted that directions pointed by arrows in FIG. 1 to FIG. 5 are directions in which light illuminates.

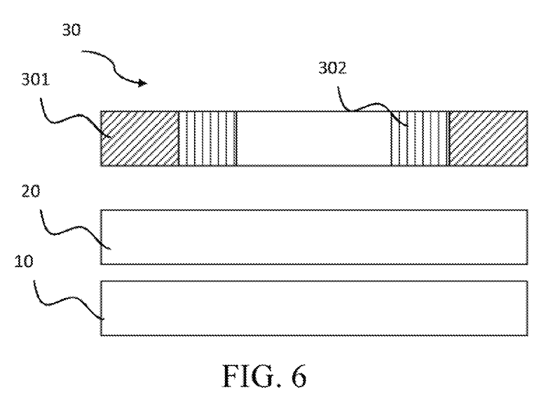

As shown in FIG. 6, the liquid crystal display apparatus provided in this embodiment of this application may include: the backlight module 10; the liquid crystal display panel 20, disposed on the backlight module, where the liquid crystal display panel includes a plurality of image pixels arranged in arrays; and the liquid crystal dimming panel 30, disposed on the liquid crystal display panel, where the liquid crystal dimming panel has a transparent state and a scattering state, the liquid crystal dimming panel in the transparent state allows an image represented by the image pixels to be directly viewed from a front face, and the liquid crystal dimming panel in the scattering state allows light emitted from the image pixels to be refracted and adjusted. Light emitted from the backlight module 10 is directed to the image pixels on the liquid crystal display panel, and an angular deviation between the light emitted from the backlight module and the image pixels is equal to or less than 10 degrees. The liquid crystal dimming panel has at least two pairs of dimming areas 301 and 302, and the at least two pairs of dimming areas 301 and 302 are located in pairs at two sides of the liquid crystal display panel 20 and used for adjusting the light emitted from the image pixels, so as to resolve a color cast problem during viewing at a large viewing angle.

It can be known from the foregoing that this application has the foregoing desirable features, so as to enhance the effects not existing in the related art in use, and therefore has practicability and becomes a product having a great practical value.

The foregoing descriptions are merely preferred embodiments of this application, and are not intended to limit this application. Any modification, equivalent change, or improvement made in accordance with the spirit and principle of this application shall fall within the protection scope of this application.

What is claimed is:

1. A liquid crystal display apparatus, comprising:
a backlight module;
a liquid crystal display panel, disposed on the backlight module, wherein the liquid crystal display panel comprises a plurality of image pixels arranged in arrays; and
a liquid crystal dimming panel, disposed on the liquid crystal display panel, wherein the liquid crystal dimming panel has a transparent state and a scattering state, the liquid crystal dimming panel in the transparent state allows an image represented by the image pixels to be directly viewed from a front face, and the liquid crystal dimming panel in the scattering state allows light emitted from the image pixels to be refracted and adjusted, wherein
light emitted from the backlight module is directed to the image pixels on the liquid crystal display panel, and an angular deviation between the light emitted from the backlight module and the image pixels is equal to or less than 10 degrees; and
the liquid crystal dimming panel has at least two dimming areas, and the at least two dimming areas are located at two sides of the liquid crystal display panel and used for adjusting the light emitted from the image pixels.

2. The liquid crystal display apparatus according to claim 1, wherein a plurality of dimming pixels are disposed on the liquid crystal dimming panel.

3. The liquid crystal display apparatus according to claim 2, wherein a drive voltage is the drive voltage of each dimming pixel on the liquid crystal dimming panel.

4. The liquid crystal display apparatus according to claim 2, wherein the dimming pixels are disposed in a one-to-one correspondence with an image pixel groups on the liquid crystal display panel.

5. The liquid crystal display apparatus according to claim 2, wherein the dimming pixels are disposed in a one-to-one correspondence with the image pixels in an image pixel groups.

6. The liquid crystal display apparatus according to claim 1, wherein two opposite surfaces of the liquid crystal dimming panel both comprise a transparent conductive film.

7. The liquid crystal display apparatus according to claim 6, wherein drive voltages in locations on the liquid crystal dimming panel relative to different image pixel groups are controlled by means of wiring on the transparent conductive film, so as to control photon energy adjustment, at a viewing angle, between liquid crystal molecules in the liquid crystal dimming panel.

8. The liquid crystal display apparatus according to claim 1, wherein the backlight module provides backlight for the liquid crystal display panel.

9. The liquid crystal display apparatus according to claim 8, wherein the backlight module comprises one or more light emitting points.

10. The liquid crystal display apparatus according to claim 9, wherein a spotlight component is disposed at the light emitting point.

11. The liquid crystal display apparatus according to claim 8, wherein the backlight is collimated light illuminating the liquid crystal display panel.

12. The liquid crystal display apparatus according to claim 2, wherein the liquid crystal display apparatus further comprises a signal modem configured to modulate or demodulate a picture signal received by the liquid crystal display apparatus and a controller electrically connected to the signal modem.

13. The liquid crystal display apparatus according to claim 12, wherein the controller controls, according to the signal modulated or demodulated by the signal modem, a drive voltage of the image pixel on the liquid crystal display panel and the drive voltage of the dimming pixel on the liquid crystal dimming panel.

14. The liquid crystal display apparatus according to claim 12, wherein the liquid crystal display apparatus further comprises an eye tracking apparatus electrically connected to the controller and configured to track and determine a location of the eyes of a viewer relative to the liquid crystal display apparatus.

15. The liquid crystal display apparatus according to claim 14, wherein the eye tracking apparatus is a charge coupled device (CCD) positioning apparatus.

16. A liquid crystal display apparatus, comprising:
a backlight module;
a liquid crystal display panel, disposed on the backlight module, wherein the liquid crystal display panel comprises a plurality of image pixels arranged in arrays; and
a liquid crystal dimming panel, disposed on the liquid crystal display panel, wherein the liquid crystal dimming panel has a transparent state and a scattering state, the liquid crystal dimming panel in the transparent state allows an image represented by the image pixels to be directly viewed from a front face, and the liquid crystal dimming panel in the scattering state allows light emitted from the image pixels to be refracted and adjusted, wherein
light emitted from the backlight module is directed to the image pixels on the liquid crystal display panel, and the angular deviation between the light emitted from the backlight module and the image pixels is equal to or less than 10 degrees;
the liquid crystal dimming panel has at least two pairs of dimming areas, and the at least two pairs of dimming areas are located in pairs at two sides of the liquid crystal display panel and used for adjusting the light emitted from the image pixels;
a plurality of dimming pixels are disposed on the liquid crystal dimming panel, and a drive voltage is the drive voltage of each dimming pixel on the liquid crystal dimming panel; and
two opposite surfaces of the liquid crystal dimming panel both comprise a transparent conductive film, and drive voltages in locations on the liquid crystal dimming panel relative to different image pixel groups are controlled by means of wiring on the transparent conductive film, so as to control photon energy adjustment, at a viewing angle, between liquid crystal molecules in the liquid crystal dimming panel.
